(19) United States
(12) Patent Application Publication
(10) Pub. No.: US 2025/0199994 A1
(43) Pub. Date: Jun. 19, 2025

(54) PARALLEL PROCESSING USING A MICROCONTROLLER BASED COMPUTING APPARATUS

(71) Applicant: Jean Michel SELLIER, Montreal (CA)

(72) Inventor: Jean Michel SELLIER, Montreal (CA)

(21) Appl. No.: 18/845,686

(22) PCT Filed: Apr. 5, 2022
(86) PCT No.: PCT/IB2022/053166

§ 371 Date: Sep. 10, 2024

(51) Int. Cl. G06F 15/173; G06F 15/17

(52) U.S. Cl. CPC G06F 15/17318; G06F 15/17

(57) ABSTRACT

The disclosure relates to a computing apparatus, for parallel computing, a method, a system, and a non-transitory computer readable media. The computing apparatus comprises a plurality of microcontrollers, including a master microcontroller and at least two slave microcontrollers. The computing apparatus comprises a bus, operatively interconnecting the plurality of microcontrollers. The computing apparatus comprises an input/output (I/O) interface operatively interconnected to the master microcontroller. The computing apparatus comprises a power supply. The master microcontroller is operative to receive executable fdes through the I/O interface, to distribute the executable fdes to the at least two slave microcontrollers, to receive a response from the at least two slave microcontrollers and to transmit an aggregated response through the I/O interface.

### TECHNICAL FIELD

The present disclosure relates to parallel processing using a microcontroller based computing apparatus.

### BACKGROUND

Fifth generation (5G) networks (and beyond) come with the great promise of faster speeds, eventually reaching up to 10 Gbit/second in download. These impressive speeds are going to be achieved in mainly two ways: 1) on the one hand, additional higher frequencies will be in use, bringing to the need of developing, and deploying, smaller cells in a dense manner in urban areas (distant 250 meters from each other) and 2) on the other hand, by means of a massive use of artificial intelligence (AI).

Therefore, it can be easily foreseen that data centers and edge computing devices, which can be seen as an application of the Internet of things (IoT), are going to be critical for the development and deployment of this new type of networks. These two different computing device paradigms (centers and edges) will require important computational capabilities to effectively support a level of automatism (through AI techniques) never seen in the previous communication networks. Because the use of these computational devices might be on both sides (centers or edges), and because they will be both required/installed in large numbers, it is also important that their carbon footprint remains acceptable (which is, unfortunately, not the case with the hardware necessary to run AI algorithms nowadays).

From a purely data center perspective, a common technique to speed up computations consists in using parallel hardware which can perform a certain number of mathematical operations at the same time. The greater is the number of operations possible, the faster the computation goes. Nowadays, two main parallel computational resources are available for the market, i.e., mainstream (a.k.a. Beowulf) clusters and graphics processing units (GPUs). The former technology can be considered as a cluster of commodity-grade computers which are connected to each other into local area networks. These computing networks are, thus, obtained by utilizing both specialized hardware (server motherboards, ethernet boards, etc.) and software (operating systems, communication protocols, etc.), consequently requiring a relevant amount of power to function. The second technology can be seen as a specialized electronic circuit which performs rapid manipulations and alterations of memory data (mainly for computer graphic related purposes). Both technologies are not suitable for 5G networks (and beyond) processing needs.

From a purely edge computing perspective, the most common hardware in use is represented by either simple microcontrollers (MCUs) or systems on chip (SoC) (such as Raspberry Pi or Nvidia Jetson). The MCU is known to have limitations which prevent any meaningful aspect of AI on the edge. In the SoC, parts of the computational resources are constantly consumed by the operating system which needs to run on these machines; moreover, their carbon footprint can be quite important too.

### SUMMARY

Because of the reasons discussed above, it becomes desirable to develop a parallel computing device having the following features (important in the context of 5G networks):
the device should provide relevant computational resources in terms of speed and memory;
the cost for such device should be reasonable to allow the construction of powerful clusters;
the device design should be flexible enough to easily adapt to any situation from the edge to the center;
the device should have a low carbon footprint to allow the deployment of low power, energy efficient communication networks;
the device should come in a small package, possibly without the need for a cooling system (so that its dimensions remain small, and its carbon footprint remains low).

Clearly, a new kind of computational parallel resource needs to be designed as no currently available technology includes all the above features. Without this new technology, it is difficult to imagine efficient and low carbon footprint 5G networks that are able to run AI algorithms on both the center and the edges.

The parallel machine and its software framework, presented and discussed herein, present a new flexible, affordable, and reliable solution for the computational needs of 5G networks and beyond.

There is provided a computing apparatus, comprising a plurality of microcontrollers, including a master microcontroller and at least two slave microcontrollers. The computing apparatus comprises a bus, operatively interconnecting the plurality of microcontrollers. The computing apparatus comprises an input/output (I/O) interface operatively interconnected to the master microcontroller. The computing apparatus comprises a power supply. The master microcontroller is operative to receive executable files through the I/O interface. The master microcontroller is operative to distribute the executable files to the at least two slave microcontrollers. The master microcontroller is operative to receive a response from the at least two slave microcontrollers. The master microcontroller is operative to transmit an aggregated response through the I/O interface.

There is provided a method for parallel computing, using a computing apparatus. The computing apparatus comprises a plurality of microcontrollers, including a master microcontroller and at least two slave microcontrollers. The computing apparatus comprises a bus, operatively interconnecting the plurality of microcontrollers. The computing apparatus comprises an input/output (I/O) interface operatively interconnected to the master microcontroller. The computing apparatus comprises a power supply. The method comprises, the master microcontroller receiving executable files through the I/O interface. The method comprises, the master microcontroller distributing the executable files to the at least two slave microcontrollers. The method comprises, the master microcontroller receiving a response from the at least two slave microcontrollers. The method comprises, the master microcontroller transmitting an aggregated response through the I/O interface.

There is provided a system comprising the computing apparatus, as previously described, and a computer connected to the master node through the I/O interface.

There is provided a non-transitory computer readable media having stored thereon instructions for parallel computing, using a computing apparatus comprising a plurality of microcontrollers, including a master microcontroller and at least two slave microcontrollers. The computing apparatus comprises a bus, operatively interconnecting the plurality of microcontrollers. The computing apparatus comprises an input/output (I/O) interface operatively interconnected to the master microcontroller. The computing apparatus comprises a power supply. The instructions comprise, the master microcontroller receiving executable files through the I/O interface. The instructions comprise, the master microcontroller distributing the executable files to the at least two slave microcontrollers. The instructions comprise, the master microcontroller receiving a response from the at least two slave microcontrollers. The instructions comprise, the master microcontroller transmitting an aggregated response through the I/O interface.

### BRIEF DESCRIPTION OF THE DRAWINGS

FIG. 1a is a picture of an example microcontroller.

FIG. 1b is a picture of an example printed circuit board.

FIG. 2 is a picture of an example assembly of microcontrollers.

FIGS. 3a and 3b are pictures of a prototype that was built as a proof of concept.

FIG. 4 is a schematic illustration of the computing apparatus.

FIG. 5 is a block diagram of an example microcontroller.

FIG. 6 is a sequence diagram illustrating steps for using the prototype of FIG. 3.

FIG. 7 is a flowchart of a method for parallel computing using the computing apparatus.

### DETAILED DESCRIPTION

Various features will now be described with reference to the drawings to fully convey the scope of the disclosure to those skilled in the art.

Sequences of actions or functions may be used within this disclosure.

The functions/actions described herein may occur out of the order noted in the sequence of actions or simultaneously. Furthermore, in some illustrations, some blocks, functions or actions may be optional and may or may not be executed; these are generally illustrated with dashed lines.

Further, computer readable carrier or carrier wave may contain an appropriate set of computer instructions that would cause a processor to carry out the techniques described herein.

The main computational resources on the market for center and edge computing can be classified in MCUs, SoCs, GPUs and clusters. While they continue to provide interesting capabilities in certain fields of science and technology, it is difficult to see how they could concretely contribute to the deployment of the various AI algorithms which future networks will rely on.

In particular:
Computer motherboards in the so-called “pizza boxes” form factor, which tend to be flat and wide, consume power just as any other desktop computer, i.e., a minimum of 430 Watt. Thus, although they provide relevant computational power, they do not qualify as low impact technology. Moreover, they come in cumbersome dimensions. The same applies, consequently, to clusters.
GPUs represent a relevant computational resource in several fields such as neural network training and computer graphics, since their hardware has been highly specialized for this kind of use. Unfortunately, though, they are not suitable for general purpose computing. Moreover, their power consumption is around a minimum of 500 Watt, not to mention that they can work only in the presence of a computer to which they must be connected (therefore, they cannot come in small packages).
MCUs comes in small packages with various computational capabilities. At the filing date of this patent application, the best MCUs belong to the family of advanced RISC machine (ARM) devices known as the Cortex-M. A typical MCU from this family runs at 600 MHz and comes with a handful of megabytes of random-access memory (RAM). While they consume very low power, it is hard to imagine how to achieve anything computationally meaningful on such limited resources.
SoCs are essentially affected by the same issues that affect motherboards.

They come in relatively big packages and their power consumption is relatively high.

Clearly, the computational devices on the market today do not provide a reasonable solution to the computational needs of 5G networks and beyond.

The parallel computing device presented herein can be considered as a cluster of connected, modem, low cost and energy efficient MCUs capable of performing relevant and meaningful computations, reaching the very same capabilities and flexibility of mainstream clusters, but at lower costs, lower power consumptions, and in relatively small packages. Specific MCUs (as will be described below) have been selected and connected to obtain a machine capable of relevant performances without the need for cooling systems and/or high-power supply, and without the need for an operating system running on the MCUs or the equivalent of the message passing interface (MPI) library, which is a standard library for node communications, therefore, further reducing the need for electric power.

In order to concretely assess the performances and feasibility of such proposed technology, a prototype of the proposed architecture (made of 22 MCUs) has been built and tested on a quite complex computational validation benchmark, i.e., the simulation of the H₂ and HeH molecules by means of the well-known Hartree-Fock method. Not only these are archetypal validation tests very well-known (and recognized) in quantum chemistry, but they also represent quite complex computational problems, therefore clearly showing that this new machine is capable of providing the computational resources required in the context of 5G networks (and beyond).

Recently, anew series of ARM 32-bit RISC, low cost and energy efficient MCUs have been released, under the name of “Cortex-M”. In particular, these new MCUs come with very interesting computational capabilities: for instance, the Cortex-M7 runs at 600 MHz without any cooling system and can address memory up to 4 Gigabytes (the Cortex-M7 MCU is, obviously, one possible choice, but the parallel device described in this document is not limited to any particular MCU model selected from this family).

This new kind of MCUs allows the design and construction of interesting parallel devices capable of quite impressive computations, paving the way towards the development of flexible/adaptable parallel devices in small packages, being low powered and at drastically lower costs (literally orders of magnitude smaller), especially if compared to mainstream clusters. The parallel computing device described herein represents an excellent solution for the issues mentioned previously in the context of 5G networks and beyond.

In more technical details, this parallel device is constituted of MCUs connected with each other in a master-slave fashion, through the inter-integrated circuit (I2C) communication protocol, which is a protocol for circuit communications, and thus the MCUs are hard wired with each other.

An accompanying software framework has also been developed to handle and program such machine (which is described in great details below). Consequently, this machine does not necessitate any operating system (such as GNU/Linux on mainstream clusters) and/or communication libraries (such as the standard MPI on mainstream clusters).

The parallel device described in detail below provides relevant/meaningful computational resources, and an effective and simple way to program it, with the following important benefits/advantages:
lower cost;
lower power consumptions, which can be hundreds of times lower for equivalent computing power;
no need for cooling systems;
small package;
versatile architecture, the parallel machine described herein can have any number of MCUs and the proposed architecture scales easily; the computational capabilities can be increased, or decreased, by adding, or removing, one MCU at a time, while following the same connection scheme for every MCU added/removed;
simplicity of programming general computational algorithms; the networks of MCUs can be used in exactly the same way one can program mainstream clusters through the MPI protocol, i.e., as a general parallel computing machine; programming the machine does not require programming every single MCU by hand as everything is handled automatically by the framework proposed herein;
channel capacity, i.e., the rate of information that can be reliably transmitted over the available communication channel is performed through the serial peripheral interface (SPI) protocol; this protocol is usually embedded electronically, i.e., in hardware, in the MCUs available nowadays; this represents an advantage over the channel capacity exploited by a software implementation of a protocol such as MPI.

The hardware architecture.

The parallel computing device presented herein can be considered as an improvement over the mainstream Beowulf cluster technology. In essence, these clusters are made by connecting motherboards (called the nodes) to each other, usually through ethernet cards, and by running a common operating system and a common communication protocol at each node. In this paradigm, a master-slave scheme is usually adopted, thus having one node behaving as the master and all others as the slaves. This approach has allowed the development of efficient parallel machines which achieve general computing capabilities and computational speeds. In the current status of this technology, every node is represented by a rather cumbersome computing device (both in terms of dimensions and power consumption), and, consequently, the final outcome is a powerful but cumbersome parallel machine (which comprise several racks of “pizza-box” computation units). Moreover, these machines require significant cooling systems, critical for their correct functioning (thus, more power consumption). This approach, i.e., nodes made of common motherboards with an operating system and a communication protocol, is well-known to be a serious burden in terms of dimensions and energy consumptions.

Thanks to the latest developments in the field of MCU technology, a solution to this problem is within reach nowadays, which provides smaller and energy efficient MCUs, rather than motherboards, and could be utilized to create a new kind of parallel computing machine.

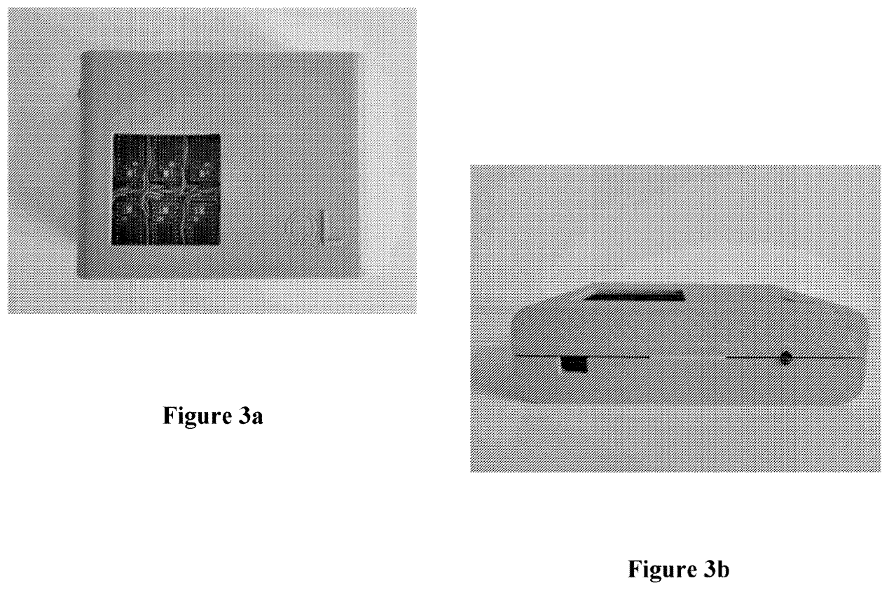

A software framework can be developed to enable easy programming of such machine, which would be a sort of MPI for clusters made of MCUs. A prototype of such machine was built as a proof of concept and is shown in FIGS. 3a and 3b (top and side view of the prototype). Further, several parallel computational algorithms have been run on the prototype to validate this new approach to parallel computing.

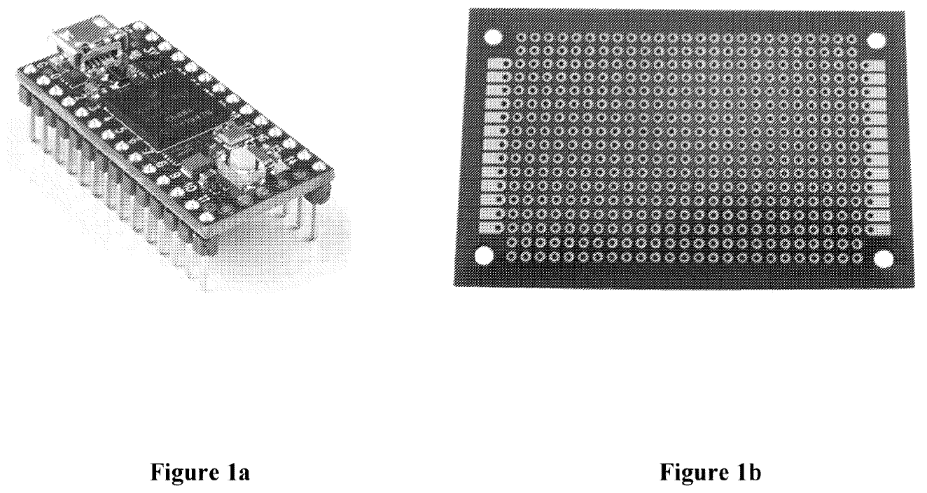

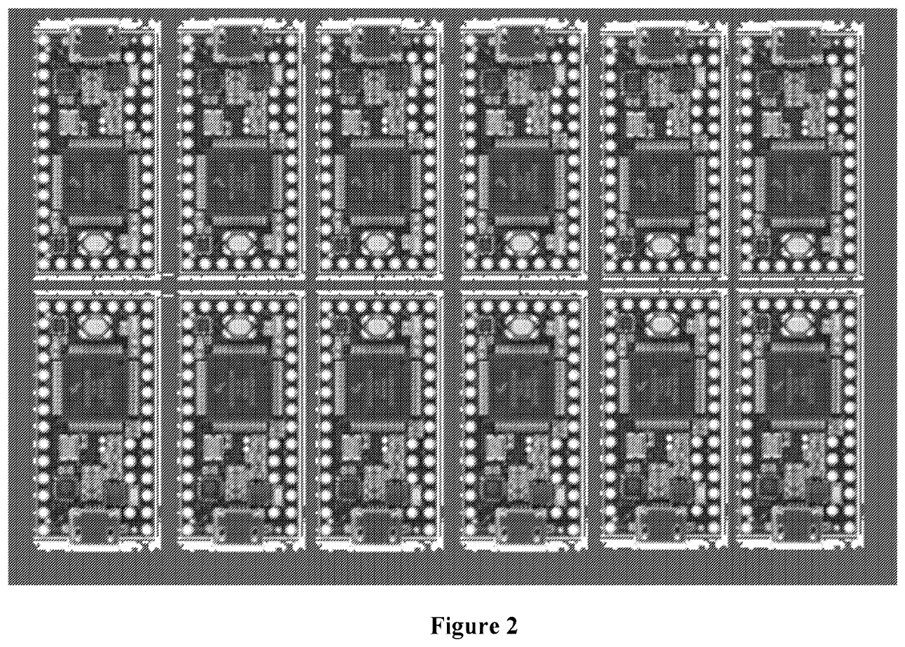

The prototype machine is made of 22 MCUs (1 master and 21 slaves, this number is arbitrary and other machines with a different number of nodes can be readily obtained by using the same techniques). In particular, 22 Cortex-M7 embedded on development boards known as Teensy 4.0 (FIG. 1a) have been arranged on two printed circuit boards (FIG. 1b), to obtain the configuration shown in FIG. 2. The (arbitrary) number of MCUs does not constitute a limitation as it could be easily increased and/or decreased depending on the computational needs (just like one would add and/or remove motherboards from a mainstream cluster), in other words generalizations are quite straightforward. Therefore, the prototype consists of 2 boards containing 12 and 10 MCUs respectively, where one MCU is utilized as the master while the other MCUs represent the computing nodes (in other words, the slaves).

The communication bus consists of simple wires with pull-up resistors (when needed to strengthen the signal over the bus). Only one power supply is necessary which consists of a 110 Volt-12 Volt converter (0.5 Ampere in output) which is, in turn, transformed into 5 Volt.

The connection between the MCUs happens through the I2C communication protocol which is a standard communication protocol in digital electronics, and which is embedded in hardware form in the vast majority of MCUs available on the market nowadays (rather than the usual MPI protocol which is used for mainstream clusters). The reason for selecting this type of connection/protocol is twofold:
on one hand, it does not require the implementation of any software (as being directly embedded in the hardware of the MCU);
on the other hand, it requires less wiring than other communication protocols (for instance, SPI requires 4 wires between 2 MCUs to work properly, while 12C requires only 3 wires) while still providing fast communication capabilities.

Finally, the connection between the master node of the prototype and a personal computer (PC) can be easily achieved, if/when necessary (for instance, for programming purposes), by connecting the master MCU of the prototype to the USB port of the PC and then, by using the universal asynchronous receiver-transmitter (UART) and/or universal synchronous and asynchronous receiver-transmitter (USART) protocol.

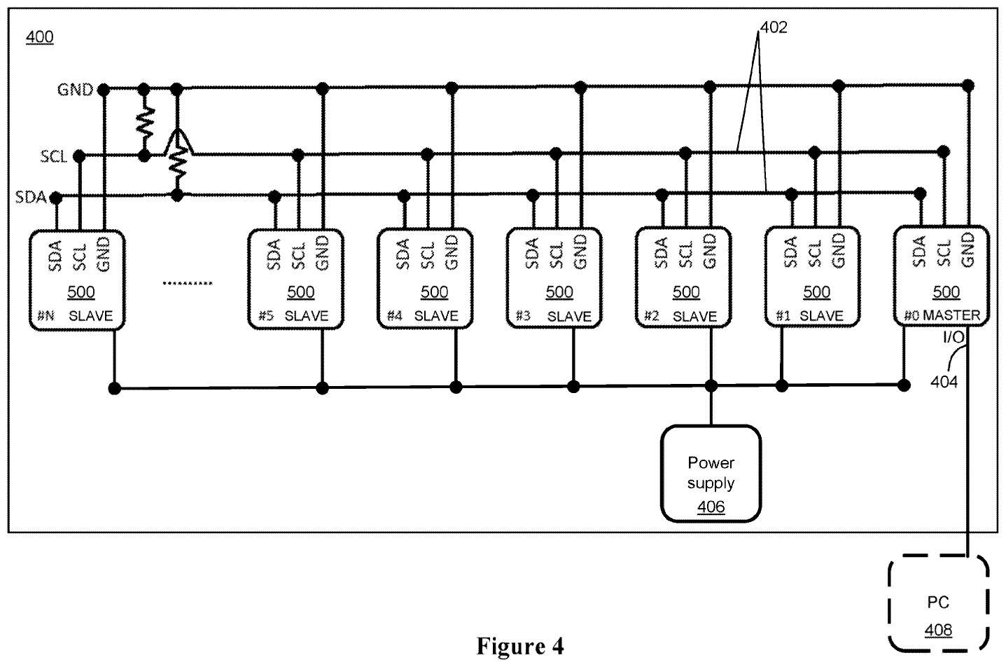

A schematic diagram of the interconnections of the computing apparatus 400 is provided in FIG. 4. The schematics of FIG. 4 represents N+1 microcontrollers 500 connected in a master-slave network, with the 0-th node being the master unit and the other nodes being the slaves. Communication between the master and the slaves is achieved by utilizing the I2C protocol and, therefore, requires two lines or buses 402, one for the serial data (SDA) signal, the other for the serial clock (SCL) signal. All units are connected to the same ground point (GND) and two pull-up resistors are added (top left of the figure) with a value of 100 Ohm. The master node is connected 404 to the PC 408 through the UART protocol. It receives, in this way, instructions from the user for the computation to be performed.

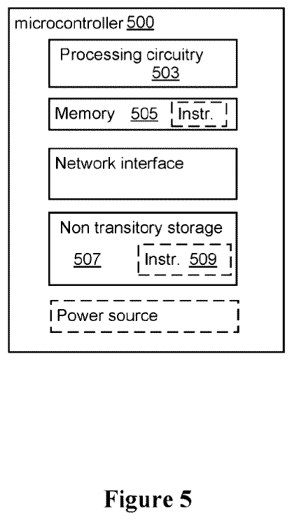

Referring to FIG. 5, there is provided a microcontroller 500.

The microcontroller 500 comprises processing circuitry 503 and memory 505. The memory 505 can contain instructions executable by the processing circuitry 503 whereby functions and steps described herein may be executed to provide any of the relevant features and benefits disclosed herein.

The microcontroller 500 may also include non-transitory, persistent, machine-readable storage media 507 having stored therein software and/or instruction 509 executable by the processing circuitry 503 to execute functions and steps described herein. The microcontroller may also include I/O interface(s) and a power source or way to attach to a power source.

The instructions 509 may include a computer program for configuring the processing circuitry 503. The computer program may be stored in a physical memory local to the microcontroller.

The computer program may also be embodied in a carrier such as an electronic signal, optical signal, radio signal, or computer readable storage medium external to the microcontroller.

Referring to FIGS. 4 and 5, there is provided a computing apparatus 400. The computing apparatus comprises a plurality of microcontrollers 500, including a master microcontroller and at least two slave microcontrollers. The computing apparatus comprises a bus 402, operatively interconnecting the plurality of microcontrollers. The computing apparatus comprises an input/output (I/O) interface 404 operatively interconnected to the master microcontroller. The computing apparatus comprises a power supply 406. The master microcontroller is operative to receive executable files through the I/O interface. The master microcontroller is operative to distribute the executable files to the at least two slave microcontrollers. The master microcontroller is operative to receive a response from the at least two slave microcontrollers. The master microcontroller is operative to transmit an aggregated response through the I/O interface.

In the context of this specification, aggregated can take different meanings, but is generally used in the sense of transmitting in one transmission. Sometimes, computation results from the microcontrollers will be in the form of arrays, sometimes results will be scalars (i.e., single values), etc. The master microcontroller will regroup all the computation results (aggregate the results) and transmit these results through the I/O interface. The master microcontroller could transmit a unique value, one value per microcontroller, an array of values, multiple arrays of values, or any other suitable data format etc. as would be apparent to a person skilled in the art. The master microcontroller may or may not apply calculations to the computation results received from the slave microcontrollers before transmission.

The bus 402 operatively interconnects the plurality of microcontrollers in parallel. The bus may be composed of hard wires. More specifically, the bus may be composed of two hard wires, one for serial data (SDA) signal and one for serial clock (SCL) signal.

The master microcontroller may distribute the executable files and receive a response from the at least two slave microcontrollers using the inter-integrated circuit (I2C) communication protocol. It should be noted that I2C is not the only possible communication protocol that could be used. There are other protocols one could use, for instance serial peripheral interface (SPI). In practice, one should select only one protocol, but many protocol alternatives are possible.

The master microcontroller may receive the executable files and transmit the aggregated response through the I/O interface using the universal asynchronous receiver-transmitter (UART) protocol. UART is not the only possible way to connect the master MCU to a computer. For instance, USART (and many others) could alternatively be used as would be apparent to a person skilled in the art.

Each of the executable files received through the I/O interface may comprise specific instructions, to be executed by each of the plurality of microcontrollers, for executing a parallel computation. The executable files may be compiled on a computer connected to the master node and may be received through the I/O interface. The master microcontroller may further be operative to send a command to the at least two slave microcontrollers, to set the at least two slave microcontrollers in programming mode. When in programming mode, each of the at least two slave microcontrollers may be operative to write the executable file on the slave microcontroller flash memory, restart itself and wait in idle mode. The master microcontroller may further be operative to send a command to the at least two slave microcontrollers, to run the executable files. The master microcontroller may further be operative to send a command to the at least two slave microcontrollers, to send a response to the master microcontroller.

There is provided a system comprising the computing apparatus 400 and a computer 408 connected to the master node through the I/O interface.

There is also provided, a non-transitory computer readable media 507 having stored thereon instructions 509 for parallel computing, using a computing apparatus. The computing apparatus comprising a plurality of microcontrollers, including a master microcontroller and at least two slave microcontrollers. The computing apparatus comprising a bus, operatively interconnecting the plurality of microcontrollers. The computing apparatus comprising an input/output (I/O) interface operatively interconnected to the master microcontroller. The computing apparatus comprising a power supply. The instructions comprising, the master microcontroller receiving executable files through the I/O interface, distributing the executable files to the at least two slave microcontrollers, receiving a response from the at least two slave microcontrollers and transmitting an aggregated response through the I/O interface. The non-transitory computer readable media may further comprise instructions for executing any of the steps described herein.

The software framework.

To obtain general computing capabilities by means of the above architecture, one cannot rely on the typical software infrastructure utilized by mainstream Beowulf clusters (usually a mixture of the Linux O.S. and the MPI protocol) since they simply cannot run on MCUs. Therefore, a software framework is necessary, which has been developed for the prototype. This software framework makes the proposed architecture easily programmable for the purpose of general parallel computing.

The standard library “Wire”, for Atmel and/or ARM MCUs, was used and a working programmable machine was developed which handles the situation in which a user develops a general parallel computing code to run on the machine. At a high level of description, this framework allows four important components:
a way for the user to program the machine from a common PC through the universal serial bus (USB) port;
a way for the master MCU to broadcast the above program to the slave MCUs;
a way for the master MCU to run a particular computational task on the slave MCUs; and
a way for the master MCU to request the results computed by the slave MCUs.

To provide a simple and effective way for the user to program any parallel computational algorithm on the machine, a template implemented in the C language is provided to the user for the description of three components of the parallel algorithm to run on the machine, which involves 1) the input structure for the slave MCUs (i.e., the input data the slave MCUs need to run the computation), 2) the output structure for the slave MCUs, (i.e., the result provided by the slave MCUs at the end of the computation), and 3) the computational routine itself (i.e., the actual computation performed by the slave MCUs, which is slave identity (ID) dependent).

The template reads as:

```
struct input_structure{
  // describe the input for the slave computation here
}
struct output_structure{
  // describe the output of the slave computation here
}
output_structure computation(int ID) {
  // this is where the actual slave computation is described
}
```

Thus, the words “input_structure”, “output_structure” and “computation” are now reserved words of the proposed software infrastructure.

For the sake of clarity, a simple and concrete example is provided below which consists of two inputs (two double variables, called “a”, “b”), one output (one double variable, called “sum”) and a function adding the two inputs on every slave MCU. The input is the same for every slave MCU (i.e., it is independent from the MCU ID), where “a” is equal to 1 and “b” is equal to 2, therefore each slave MCU performs the same computation:

```
struct input_structure{
  double a;
  double b;
}
struct output_structure{
  double sum;
}
output_structure computation(int ID) {
  input_structure input_MCU;
  output_structure output_MCU;
  input_MCU.a=1;
  input_MCU.b=2;
  output_MCU.sum = input.a + input.b;
  return(output_MCU) ;
}
```

For completeness, another example is reported below where the computation is now depending on the ID of the slave MCU:

```
output_structure computation(int ID) {
  input_structure input_MCU;
  output_structure output_MCU;
  // input for the MCUs with even ID
  if(ID%=0) {
    input_MCU.a=1;
    input_MCU.b=2;
  }
  // input for the MCUs with odd ID
  if(ID%=1) {
    input_MCU.a=3;
    input_MCU.b=4;
  }
  // same computation on every slave MCU
  output_MCU.sum = input.a + input.b;
  return(output_MCU) ;
}
```

Once the programmer provides the above input/output structures and the computational algorithm which runs on the slave MCUs, the next step consists in creating the HEX files, i.e., the executable/binary files for the slave MCUs. In other words, an automatic compilation step is required which prepares an HEX file for every MCU. This is performed by using the above template and by embedding it in a bigger software infrastructure which can be properly compiled by a compiler for the MCU type at hand.

It should be noted that the examples provided herein are simplified for the sake of brevity and, as such, it will be apparent to a person skilled in the art that the above template would not work as it is incomplete, for instance the “main( )” function is completely missing, along with other important functions which are going to be described below (in particular, all communication functions are missing as well).

A template for the bigger software infrastructure discussed above can therefore read like the following code:

```
#include<stdio.h>
#include<stdlib.h>
#include<math.h>
#include<wire.h>
// ...
struct input_structure{
  // input structure for the slave computation
}
struct output_structure{
  // output returned by the slave MCUs
}
output_structure computation(int ID) {
  input_structure input_MCU;
  output_structure output_MCU;
  if(ID==0) {
    // ...
  } else {
    // ...
  }
  // ...
  return(output_MCU) ;
}
// SPI communication routines
void get_and_interpret_master_messages(void) {
  // ...
}
// C main function
int main(void) {
  // ...
}
```

First, a series of relevant headers is added to the template. Then, a series of SPI communication routines are added as well, which allow the slave MCUs to communicate with the master MCU and to interpret the various commands sent by the MCU master (for instance, the master can send message to program the slaves, to run computations or to collect the results computed). In particular, every time the master MCU send a message to the slave MCUs, an interrupt is triggered on the slaves and the SPI communication starts.

Finally, this code is compiled on the connected PC which creates all relevant HEX files which need to run on the slave MCUs to achieve the specific parallel computation previously described in the template. When the compiler builds the HEX files, all global variables, static variables, and compiled code are assigned to dedicated locations of the memory. This is called static allocation since all memory addresses are fixed. By default, the compiler tries to use the ultra-fast data tightly coupled memory (DTCM) & instruction tightly coupled memory (ITCM) available on the MCU. When compiling, it is possible to control the allocation by means of keywords and one can choose where the compiler will place the variables and the code within the memory. The prototype described in this document achieves this step by using parts of the code available at https://github.com/PaulStoffregen/teensy_loader_cli at the time of filing of this application, running directly on the slave MCUs (i.e., the slave MCUs can reprogram themselves when required by the master MCU).

At this point, the HEX files are ready to be written on the Flash memory of the slave MCUs. This can be done in several ways, such as by static memory allocation (which is readily available for a plethora of different MCU models). As a first step, a command is sent from the master MCU to the slave MCUs to set these last ones in programming mode. Then, the various HEX files are sent to the slaves which write them on the flash memory, restart themselves and wait idle for the master MCU to provide the command which runs the computations.

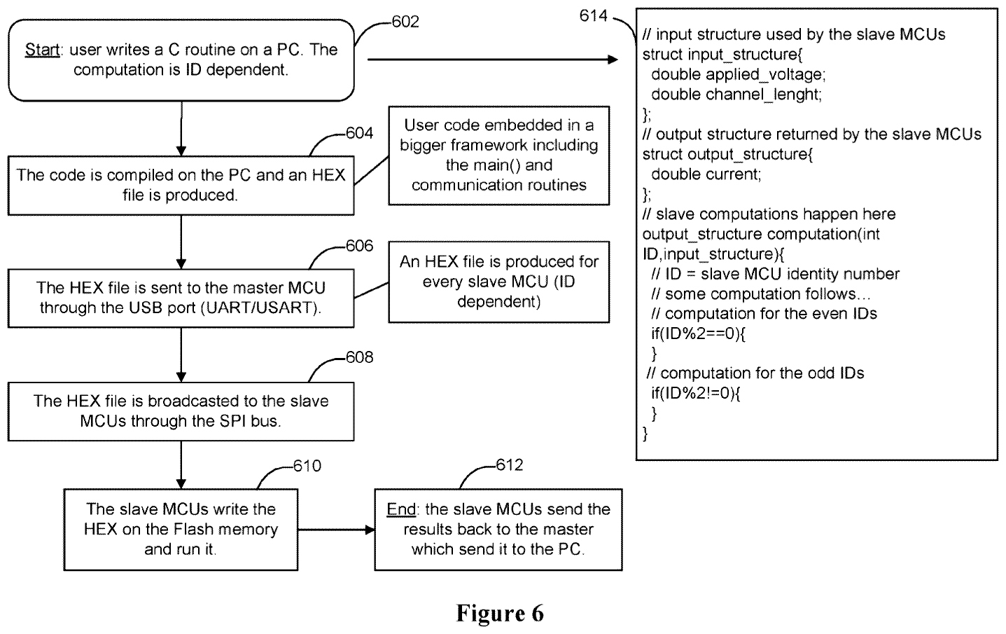

To conclude this part, for the sake of clarity, a sequence diagram is presented in FIG. 6 that shows how the process described above works on the prototype. The process starts with a user writing a C routine 614 on a computer, step 602, using the templates as presented previously. The user decides at this time how to use the different slave nodes for achieving parallel computing and can provide different code for the different nodes, with associated ID. Alternatively, in a more advanced embodiment, this could possibly be done automatically, with the use of libraries, for example. Then, the code is compiled on the PC and HEX files are produced, step 604. The HEX files are sent the master node MCU through a port, such as a USB port (UART/USART), step 606. The HEX files are then broadcasted to the slave MCUs through the SPI bus, step 608. The slave MCUs write the HEX files on their flash memory and run it, step 610. The process ends when the slave MCUs send back the result to the master MCU which in turn sends it to the PC, step 612.

A person skilled in the art would understand that a commercial application could differ from the prototype described above and that particular commercial applications are intended to be covered through the general concepts described herein.

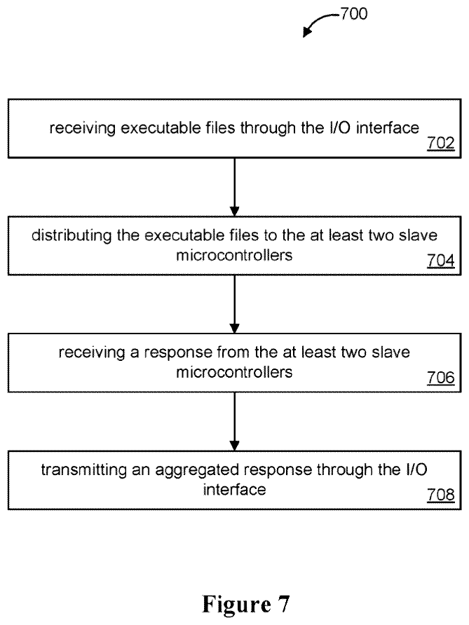

Referring to FIGS. 4 and 7, there is provided a method 700 for parallel computing, using a computing apparatus. The computing apparatus comprises a plurality of microcontrollers 500, including a master microcontroller and at least two slave microcontrollers. The computing apparatus comprise a bus 402, operatively interconnecting the plurality of microcontrollers. The computing apparatus comprises an input/output (I/O) interface 404 operatively interconnected to the master microcontroller. The computing apparatus comprises a power supply 406. The method comprises, the master microcontroller receiving, step 702, executable files through the I/O interface. The master microcontroller distributing, step 704, the executable files to the at least two slave microcontrollers. The master microcontroller receiving, step 706, a response from the at least two slave microcontrollers. The master microcontroller transmitting, step 708, an aggregated response through the I/O interface.

The master microcontroller may further receive the executable files through the I/O interface, where the executable files are compiled on a computer 408 connected to the master node through the I/O interface 404. The master microcontroller may further send a command, to the at least two slave microcontrollers, to set the at least two slave microcontrollers in programming mode.

When in programming mode, each of the at least two slave microcontrollers may write the executable file on the slave microcontroller flash memory, restart itself and wait in idle mode. The master microcontroller may further send a command to the at least two slave microcontrollers, to run the executable files. The master microcontroller may further send a command to the at least two slave microcontrollers, to send a response to the master microcontroller.

### Examples

Three simple examples are presented below which involve: 1) the computation of an integral by means of a brute force Monte Carlo technique, 2) the computation of the (irrational) number π and 3) the training of an artificial neural network by means of the stochastic gradient descent (SGD) method. Part of the code is shown as well for the sake of clarity.

Monte Carlo computation of integrals.

In this section, the problem of integrating a given function ƒ=ƒ(x) over a given domain Ω by means of the brute force Monte Carlo (MC) method is presented, i.e., the following quantity is computed:

$$I = {\int }_{Ω} f ( x ) dx$$

Although better Monte Carlo methods exist for this problem, the brute force approach is simple enough to provide a comprehensible starting point on how programmers can utilize the machine described herein for parallel computing. The brute force MC method consists in uniformly sampling the domain Ω, by means of N points x₁, x₂, . . . , x_{N}, and then averaging by means of the following formula (in other words, it is an approximation of the exact value):

$$I \approx \frac{V}{N} {\sum }_{i = 1}^{N} f ( {x}_{i} )$$

where

$$V = {\int }_{Ω} dx .$$

Such algorithm is parallelizable and a possible implementation of the corresponding code for the machine described herein could read as follows:

```
#include<math.h>
// integration of a function over a one-dimensional domain
struct input_structure{
  // interval [x_i, x_f]
  double x_i; // initial value of the integration interval
  double x_f; // final value of the integration interval
}
struct output_structure{
  // output returned by the slave MCUs
  double I;
}
// an integrable function..
double f(double x) {
  return(2.*x*x) ;
}
output_structure computation(int ID) {
  int i;
  int N;
  int iseed;
  input_structure input_MCU;
  output_structure output_MCU;
  srand(ID) ; // the seed for random numbers is different for
every slave MCU
  // same interval for all slave MCUs
  input_MCU.x_i=0.;
  input_MCU.x_f=1.;
  // total number of samples
  N=1000;
  // MC algorithm
  output_MCU.I=0.;
  for(i=0;i<=N;i++) {
    double r;
    r=rand( )/RAND_MAX; // random number in range [0, 1]
    output_MCU.I+=f(input_MCU.x_i+r*(input_MCU.x_f-
input_MCU.x_i)) ;
  }
  output_MCU.I*=(input_MCU.x_f-input_MCU.x_i)/N;
  return(output_MCU) ;
}
```

Estimation of the π number.

It is possible to compute the irrational number π by means of the following MC method: randomly generate the coordinates of N points (xᵢ, yᵢ) in the domain [−1, 1]×[−1, 1], then count the number of points which lie inside the circle centered at (0, 0) and with radius 1, say M. Then an estimation of the number π is readily obtained, i.e., M/N. The code to implement such relatively simple algorithm is provided below:

```
#include<math.h>
// integration of a function over a one-dimensional domain
struct input_structure{
  // total number of points to generate
  int N;
}
struct output_structure{
  // total number of points in the circle
  int M;
}
// this function checks if the point (x, y)
// lies inside the circle. In the positive case,
// it returns 1, otherwise 0.
int f(double x,double y) {
  double r;
  r=sqrt(x*x+y*y) ;
  if(r<1.) return(1) ;
  else return(0) ;
}
output_structure computation(int ID) {
  int i;
  input_structure input_MCU;
  output_structure output_MCU;
  srand(ID) ; // the seed for random numbers is different for
every slave MCU
  // the same number of point is generated on every slave MCUs
  input_MCU.N=5000;
  // to estimate the pi number
  output_MCU.M=0.;
  for(i=0;i<=input_MCU.N;i++) {
    double x,y;
    x=−1.+2.*rand( )/RAND_MAX; // random number in range [−1, 1]
    output_MCU.M+=f(x,y) ;
  }
  return(output_MCU) ;
}
```

The training of artificial neural networks.

In machine learning, one important and demanding computational phase is represented by the training of a model, especially for artificial neural networks. In practice, this step consists in updating the weights (and biases) of the network until an objective function is minimized. To achieve such a task, various methods exist among which the most well-known is the stochastic gradient descent. Such method can be easily explained by the following formula:

$${w}_{i} = {w}_{i} - \frac{λ}{n} {\sum }_{j = 1}^{n} ∇ {J}_{j} ( {w}_{j} )$$

where wᵢ is the i-th weight of the network, λ is the learning rate, n is the total number of items in the batch, and the summation is the gradient of the loss function which reads:

$$J ( w ) = \frac{1}{n} {\sum }_{j = 1}^{n} {J}_{j} ( w )$$

It becomes rapidly clear how such training algorithm can be parallelized. In fact, every weight can be updated independently, therefore a certain number of weights can be scattered around the slave MCUs which perform the above computation in parallel. Part of the code for such algorithm is provided below.

```
double gradient(double w) {
  // the gradient of the loss function is computed here
  // ...
}
output_structure computation(int ID) {
  int i;
  int j;
  int start;
  int end;
  input_structure input_MCU;
  output_structure output_MCU;
  // part of the parallel stochastic gradient descent
  // ...
  // dataset items selection
  start=ID*TOTAL_NUMBER_OF_ITEMS/NUMBER_OF_MCUs;
  end=(ID+1)*TOTAL_NUMBER_OF_ITEMS/NUMBER_OF_MCUs;
  // updating the weights
  for(i=start;i<=end;i++) {
    double grad;
    grad=0.;
    for(j=start;j<=end;j++) grad+=gradient(output_MCU.w[i]) ;
    output_MCU.w[i]−=lambda/(end-start)*grad;
  }
  return(output_MCU) ;
}
```

Validation on a quantum chemistry problem.

A final (computationally complex) validation test is presented below which has been performed on the prototype described above (based on 22 MCUs).

A validation test has been performed on the prototype to assess its actual computational capabilities. This test was chosen from the field of quantum chemistry since this field is very well known to provide computationally demanding/complex problems and consists in the computation of relevant quantities related to molecules (usually more demanding than the usual AI algorithms). The numerical approach implemented for this computation is the Hartree-Fock method which is considered the archetypal model for quantum chemistry. It is applied to the H₂ and HeH⁺ molecules because they both contain the hydrogen atom which, essentially, means that a high degree of numerical difficulties is introduced by their Coulomb potential (which has a singularity at the position of the nucleus of the atom). For comparison purposes, the same computations are run on a normal PC with an Intel i7 CPU running at 3.2 GHz.

The results obtained in these two tests are quite self-explanatory:
The Intel CPU computation time was 1.066 seconds for the H₂ molecule, and 1.338 seconds for the HeH⁺ molecule.
The prototype computation time was 0.212 seconds for the H₂ molecule, and 0.223 seconds for the HeH⁺ molecule.

### Use Cases in 5G.

Finally, a list of possible use cases for this parallel machine, in the context of 5G networks, is reported below.

In the more specific case of 5G networks (and beyond), the following cases are easily foreseeable, where the available computational resources on the market are either too simple (e.g., advanced virtual reduced instruction set computer (RISC) (AVR) and/or advanced RISC machine (ARM) microcontrollers) or too big and/or power demanding (e.g., systems on chip such as Raspberry Pi or Nvidia Jetson or PC motherboards in pizza boxes form factor):

### Cloud Computing and Data Centers.

Cloud computing services are going to be more important in the context of 5G for multiple reasons. This will require, eventually, the use of data centers which are extremely expensive (even the biggest players can only afford them in small numbers). The machine described in this document could represent an affordable way to continue to use data centers, improve them while keeping their cost and environmental impact acceptable.

### Deployment of Small 5G Antennas.

Small cells, which are essentially low-powered cellular radio access nodes that operate in a spectrum that has a range of 10 meters to a few kilometers, are going to be deployed massively in the near future. In fact, small cells are currently being viewed as an important method of increasing cellular network capacity, quality, and resilience. Without small sized, low powered computational devices, it is difficult to imagine how to deploy 5G networks aiming to use AI as a core technology. The machine presented in these pages could represent a doable and effective solution in such context.

### Internet of Things.

The IoT describes the network of physical objects that are embedded with sensors, software, and other technologies that are used for the purpose of connecting and exchanging data with other devices and systems over the Internet. A challenge for producers of IoT applications is to clean, process and interpret the vast amount of data which is gathered by the sensors. Therefore, the IoT will require relevant computational power in small packages. The machine described herein can be a valid solution for such problems since it provides a way to development small, but still relevant, computational capabilities.

### Distributed AI.

The objectives of distributed artificial intelligence are to solve the reasoning, planning, learning and perception problems of artificial intelligence, especially if they require large data, by distributing the problem to autonomous processing nodes. It requires powerful centralized and decentralized computational devices with various computational capabilities. A simple solution can be provided by the machine depicted in this document, since it can be adapted to both the center and the edges of computing.

### Autonomous Vehicles.

A self-driving vehicle, also known as an autonomous vehicle, is a vehicle capable of sensing its environment and moving safely with little or no human input. Self-driving and semi-autonomous vehicles require completely autonomous capabilities when connection is lost. This will require relevant, low-powered computational resources in small packages. Once again, this problem could be easily solved by the machine presented herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computing apparatus, comprising:
a plurality of microcontrollers, including a master microcontroller and at least two slave microcontrollers;
a bus, operatively interconnecting the plurality of microcontrollers;
an input/output (I/O) interface operatively interconnected to the master microcontroller; and
a power supply;
wherein the master microcontroller is operative to:
receive executable files through the I/O interface;
distribute the executable files to the at least two slave microcontrollers;
receive a response from the at least two slave microcontrollers; and
transmit an aggregated response through the I/O interface.

2. The computing apparatus of claim 1, wherein the bus operatively interconnects the plurality of microcontrollers in parallel.

3. The computing apparatus of claim 1, wherein the bus is composed of hard wires.

4. The computing apparatus of claim 2, wherein the bus is composed of two hard wires, one for serial data (SDA) signal and one for serial clock (SCL) signal.

5. The computing apparatus of claim 4, wherein the master microcontroller distributes the executable files and receives a response from the at least two slave microcontrollers using the inter-integrated circuit (I2C) communication protocol.

6. The computing apparatus of claim 1, wherein the master microcontroller receives the executable files and transmits the aggregated response through the I/O interface using the universal asynchronous receiver-transmitter (UART) protocol.

7. The computing apparatus of claim 1, wherein each of the executable files received through the I/O interface comprise specific instructions, to be executed by each of the plurality of microcontrollers, for executing a parallel computation.

8. The computing apparatus of claim 7, wherein the executable files are compiled on a computer connected to the master node and are received through the I/O interface.

9. The computing apparatus of claim 1, wherein the master microcontroller is further operative to send a command to the at least two slave microcontrollers, to set the at least two slave microcontrollers in programming mode.

10. The computing apparatus of claim 9, wherein, when in programming mode, each of the at least two slave microcontrollers is operative to:
write the executable file on the slave microcontroller flash memory;
restart itself; and
wait in idle mode.

11. The computing apparatus of claim 10, wherein the master microcontroller is further operative to send a command to the at least two slave microcontrollers, to run the executable files.

12. The computing apparatus of claim 11, wherein the master microcontroller is further operative to send a command to the at least two slave microcontrollers, to send a response to the master microcontroller.

13. A method for parallel computing, using a computing apparatus comprising:
a plurality of microcontrollers, including a master microcontroller and at least two slave microcontrollers;
a bus, operatively interconnecting the plurality of microcontrollers;
an input/output (I/O) interface operatively interconnected to the master microcontroller; and
a power supply;
the method comprising, the master microcontroller:
receiving executable files through the I/O interface;
distributing the executable files to the at least two slave microcontrollers;
receiving a response from the at least two slave microcontrollers; and
transmitting an aggregated response through the I/O interface.

14. The method of claim 13, further comprising the master microcontroller receiving the executable files through the I/O interface, wherein the executable files are compiled on a computer connected to the master node through the I/O interface.

15. The method of claim 13, further comprising the master microcontroller sending a command, to the at least two slave microcontrollers, to set the at least two slave microcontrollers in programming mode.

16. The method of claim 15, further comprising, when in programming mode, each of the at least two slave microcontrollers:
writing the executable file on the slave microcontroller flash memory;
restarting itself, and
waiting in idle mode.

17. The method of claim 16, further comprising, the master microcontroller sending a command to the at least two slave microcontrollers, to run the executable files.

18. The method of claim 17, further comprising, the master microcontroller sending a command to the at least two slave microcontrollers, to send a response to the master microcontroller.

19. A system comprising the computing apparatus of claim 1 and a computer connected to the master node through the I/O interface.

20. A non-transitory computer readable media having stored thereon instructions for parallel computing, using a computing apparatus comprising:
a plurality of microcontrollers, including a master microcontroller and at least two slave microcontrollers;
a bus, operatively interconnecting the plurality of microcontrollers;
an input/output (I/O) interface operatively interconnected to the master microcontroller; and
a power supply;
the instructions comprising, the master microcontroller:
receiving executable files through the I/O interface;
distributing the executable files to the at least two slave microcontrollers;
receiving a response from the at least two slave microcontrollers; and
transmitting an aggregated response through the I/O interface.

21. (canceled)
